(19) United States
(12) Patent Application Publication
(10) Pub. No.: US 2007/0286435 A1
(43) Pub. Date: Dec. 13, 2007

(54) In-vehicle noise/vibration sound control system

(75) Inventors: Kosuke Sakamoto, Utsunomiya-shi (JP); Toshio Inoue, Tochigi-ken (JP); Akira Takahashi, Tochigi-ken (JP); Yasunori Kobayashi, Utsunomiya-shi (JP)

Correspondence Address: ARENT FOX LLP, 1050 CONNECTICUT AVENUE, N.W., SUITE 400, WASHINGTON, DC, 20036, US

(73) Assignee: Honda Motor Co., Ltd.

(21) Appl. No.: 11/715,396

(22) Filed: Mar. 8, 2007

(30) Foreign Application Priority Data
Mar. 29, 2006 (JP) 2006-092501

(51) Int. Cl. H04R 1/02

(52) U.S. Cl. 381/87

(57) ABSTRACT

An in-vehicle noise/vibration sound control system has an active noise control circuit for generating a noise control signal based on noise in a passenger compartment of a vehicle, together with an audio circuit for outputting an audio signal. Based on a battery voltage supplied from the vehicle battery, a first power supply voltage regulating circuit generates and supplies a first power supply voltage to both the active noise control circuit and the audio circuit. A second power supply voltage regulating circuit generates and supplies a second power supply voltage to both a condenser microphone and an adder. The in-vehicle noise/vibration sound control system is relatively small in size and weight, and also low in cost.

### BACKGROUND OF THE INVENTION

1. Field of the Invention

The present invention relates to an in-vehicle noise/vibration sound control system having a circuit board, wherein a control circuit, which is either an active noise control circuit, an active vibration control circuit, or an active sound control system, is mounted on the circuit board together with an audio circuit.

2. Description of the Related Art

Heretofore, an integrated system has been proposed for use in vehicles, which has an integrated combination of a sound control apparatus, including a sound reducing device and a sound creating device, and an audio device (see Japanese Patent No. 3261128). The proposed integrated system makes it possible to reduce noise or to adjust a sound effect depending on the acceleration or deceleration of the vehicle, while also preventing interference between the sound effect and entertainment sounds produced by the audio device.

FIG. 4 of the accompanying drawings shows a general integrated system 60 in block form. As shown in FIG. 4, the integrated system 60 comprises a sound circuit board 64, on which there are mounted a sound control circuit 62, a first power supply voltage regulating circuit 18, and a second power supply voltage regulating circuit 20. Additionally, the integrated system 60 comprises an audio circuit board 66, on which there are mounted an audio circuit 14, a first power supply voltage regulating circuit 18, a second power supply voltage regulating circuit 20, an adder 22, and an amplifier 24, a condenser microphone 16, and a speaker 26.

In the integrated system 60, the adder 22 combines a control signal generated by the sound control circuit 62 and an audio signal output from the audio circuit 14 with each other to produce a combined signal, which then is amplified by the amplifier 24. The amplified signal is output from the amplifier 24 to the speaker 26, which outputs sounds into the vehicle passenger compartment.

Since the first power supply voltage regulating circuit 18 and the second power supply voltage regulating circuit 20 that supply power supply voltages V1, V2 to each of the sound circuit board 64 and the audio circuit board 66 are mounted respectively on both the sound circuit board 64 and the audio circuit board 66, the integrated system 60 tends to be large in overall size and weight, and hence the integrated system 60 is highly costly to manufacture.

### SUMMARY OF THE INVENTION

It is an object of the present invention to provide an in-vehicle noise/vibration sound control system, which is relatively small in size and weight, and also is low in cost, wherein the sound control system has a control circuit including at least one of an active noise control circuit, an active vibration control circuit, or an active sound control system, together with an audio circuit.

According to an aspect of the present invention, the in-vehicle noise/vibration sound control system comprises a circuit board, a control circuit mounted on the circuit board, the control circuit comprising at least one of an active noise control circuit for generating a noise control signal for reducing noise in a passenger compartment of a vehicle, an active vibration control circuit for generating a vibration control signal for reducing vibration of the vehicle, and an active sound control circuit for generating a sound control signal representative of a sound change depending on a running state of the vehicle. The in-vehicle noise/vibration sound control system further includes an audio circuit mounted on the circuit board for generating and supplying an audio signal to a speaker to output music sounds therefrom, and a first power supply voltage regulating circuit mounted on the circuit board for generating a first power supply voltage based on a battery voltage supplied from a battery on the vehicle, and supplying the first power supply voltage to the control circuit and to the audio circuit.

With the above arrangement, since the first power supply voltage generated from the battery voltage by the first power supply voltage regulating circuit mounted on the circuit board is supplied to both the control circuit and the audio circuit on the same circuit board, the in-vehicle noise/vibration sound control system is relatively small in size and weight, and also low in cost.

The in-vehicle noise/vibration sound control system further comprises a microphone connected to an input of the active noise control circuit or the active sound control circuit, an adder mounted on the circuit board for combining the noise control signal or the sound control signal with the audio signal, and a second power supply voltage regulating circuit mounted on the circuit board for generating a second power supply voltage based on the battery voltage, and supplying the second power supply voltage to the microphone and to the adder.

With the above arrangement, since the second power supply voltage generated by the second power supply voltage regulating circuit on the circuit board is supplied to both the microphone and the adder, the in-vehicle noise/vibration sound control system is relatively small in size and weight, and also low in cost.

The in-vehicle noise/vibration sound control system further comprises a vibration sensor connected to an input of the active vibration control circuit, and a second power supply voltage regulating circuit mounted on the circuit board for generating a second power supply voltage based on the battery voltage, and supplying the second power supply voltage to the vibration sensor.

With the above arrangement, since the second power supply voltage generated by the second power supply voltage regulating circuit on the circuit board is supplied to the vibration sensor, the in-vehicle noise/vibration sound control system is relatively small in size and weight, and also low in cost.

The in-vehicle noise/vibration sound control system further comprises an adder mounted on the circuit board for combining the sound control signal with the audio signal, and a second power supply voltage regulating circuit mounted on the circuit board for generating a second power supply voltage based on the battery voltage, and supplying the second power supply voltage to the adder.

With the above arrangement, since the second power supply voltage generated by the second power supply voltage regulating circuit on the circuit board is supplied to the adder, the in-vehicle noise/vibration sound control system is relatively small in size and weight, and also low in cost.

According to another aspect of the present invention, an in-vehicle noise/vibration sound control system comprises a circuit board, a control circuit mounted on the circuit board, the control circuit comprising at least one of an active noise control circuit for generating a noise control signal for reducing noise in a passenger compartment of a vehicle, an active vibration control circuit for generating a vibration control signal for reducing vibration of the vehicle, and an active sound control circuit for generating a sound control signal representative of a sound change depending on a running state of the vehicle. The in-vehicle noise/vibration sound control system further includes an audio circuit mounted on the circuit board for generating and supplying an audio signal to a speaker to output music sounds therefrom, a microphone connected to an input of the active noise control circuit or the active sound control circuit, an adder mounted on the circuit board for combining the noise control signal or the sound control signal with the audio signal, and a power supply voltage regulating circuit mounted on the circuit board for generating a power supply voltage based on a battery voltage supplied from a battery on the vehicle, and supplying the power supply voltage to the microphone and to the adder.

With the above arrangement, since the power supply voltage generated from the battery voltage by the power supply voltage regulating circuit on the circuit board is supplied to both the microphone and the adder, the in-vehicle noise/vibration sound control system is relatively small in size and weight, and also low in cost.

According to still another aspect of the present invention, an in-vehicle noise/vibration sound control system comprises a circuit board, a control circuit mounted on the circuit board, the control circuit comprising at least one of an active noise control circuit for generating a noise control signal for reducing noise in a passenger compartment of a vehicle, an active vibration control circuit for generating a vibration control signal for reducing vibration of the vehicle, and an active sound control circuit for generating a sound control signal representative of a sound change depending on a running state of the vehicle. The in-vehicle noise/vibration sound control system further includes an audio circuit mounted on the circuit board for generating and supplying an audio signal to a speaker to output music sounds therefrom, a vibration sensor connected to an input of the active vibration control circuit, and a power supply voltage regulating circuit mounted on the circuit board for generating a power supply voltage based on a battery voltage supplied from a battery on the vehicle, and supplying the power supply voltage to the vibration sensor.

With the above arrangement, since the power supply voltage generated from the battery voltage by the power supply voltage regulating circuit on the circuit board is supplied to the vibration sensor, the in-vehicle noise/vibration sound control system is relatively small in size and weight, and also low in cost.

According to yet another aspect of the present invention, an in-vehicle noise/vibration sound control system comprises a circuit board, a control circuit mounted on the circuit board, the control circuit comprising at least one of an active noise control circuit for generating a noise control signal for reducing noise in a passenger compartment of a vehicle, an active vibration control circuit for generating a vibration control signal for reducing vibration of the vehicle, and an active sound control circuit for generating a sound control signal representative of a sound change depending on a running state of the vehicle. The in-vehicle noise/vibration sound control system further includes an audio circuit mounted on the circuit board for generating and supplying an audio signal to a speaker to output music sounds therefrom, an adder mounted on the circuit board for combining the sound control signal with the audio signal, and a power supply voltage regulating circuit mounted on the circuit board for generating a power supply voltage based on a battery voltage supplied from a battery on the vehicle, and supplying the power supply voltage to the adder.

With the above arrangement, since the power supply voltage generated from the battery voltage by the power supply voltage regulating circuit on the circuit board is supplied to the adder, the in-vehicle noise/vibration sound control system is relatively small in size and weight, and also low in cost.

According to the present invention, inasmuch as the first power supply voltage generated from the battery voltage by the first power supply voltage regulating circuit on the circuit board is supplied to the control circuit, which is any one of the active noise control circuit, the active vibration control circuit, or the active sound control circuit, and further, since in the audio circuit, the second power supply voltage generated by the second power supply voltage regulating circuit on the circuit board is supplied to the microphone and to the adder, the in-vehicle noise/vibration sound control system is relatively small in size and weight, and also low in cost.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of an in-vehicle noise/vibration sound control system according to a first embodiment of the present invention;

FIG. 2 is a block diagram of an in-vehicle noise/vibration sound control system according to a second embodiment of the present invention;

FIG. 3 is a block diagram of an in-vehicle noise/vibration sound control system according to a third embodiment of the present invention; and

FIG. 4 is a block diagram of a conventional integrated system.

### DESCRIPTION OF THE PREFERRED EMBODIMENTS

Preferred embodiments of the present invention shall be described in detail below with reference to the drawings.

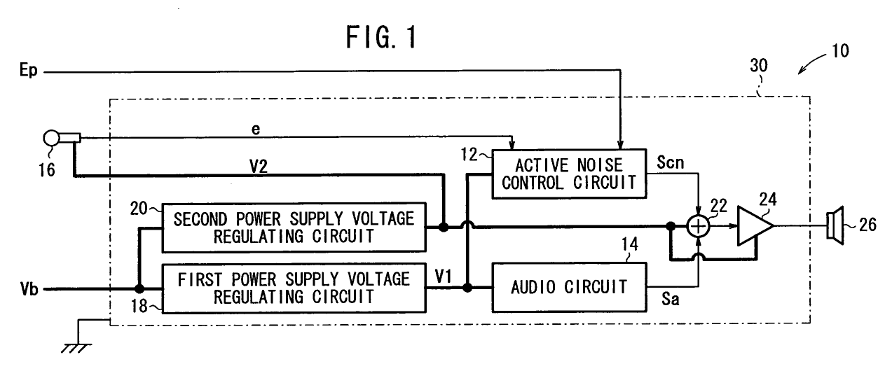

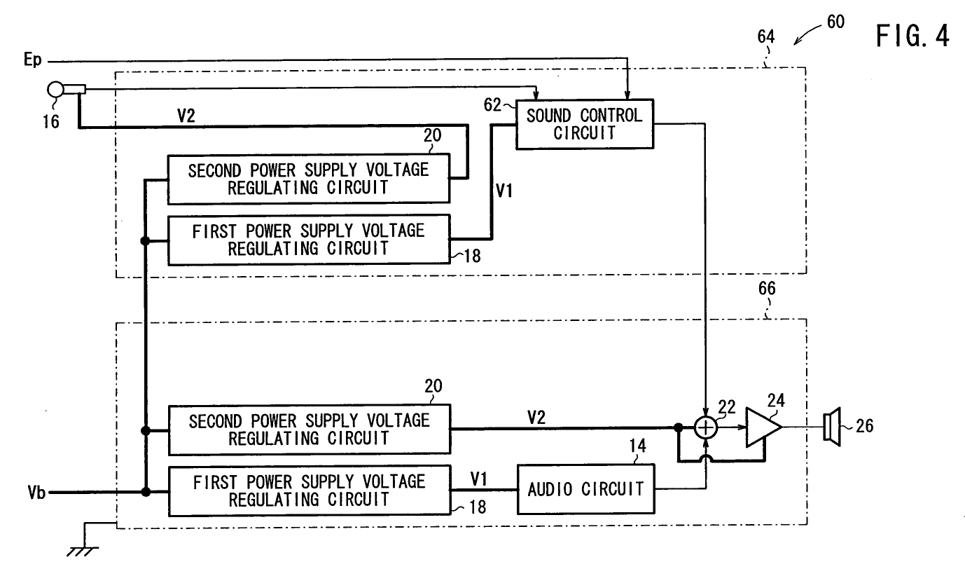

FIG. 1 shows in block form an in-vehicle noise/vibration sound control system 10 according to a first embodiment of the present invention. Those parts of the in-vehicle noise/vibration sound control system 10, which are identical to those of the general integrated system 60 shown in FIG. 4, shall be denoted using identical reference characters.

The in-vehicle noise/vibration sound control system 10 typically is installed in a vehicle, not shown. As shown in FIG. 1, the in-vehicle noise/vibration sound control system 10 has an active noise control circuit 12, an audio circuit 14, a condenser microphone 16, a first power supply voltage regulating circuit 18, a second power supply voltage regulating circuit 20, an adder 22, an amplifier 24, and a speaker 26. The active noise control circuit 12, the audio circuit 14, the first power supply voltage regulating circuit 18, the second power supply voltage regulating circuit 20, the adder 22, and the amplifier 24 are all mounted on a single circuit board 30. However, in view of the fact that the active noise control circuit 12 is made up of a small number of parts and may be installed as an optional unit in the vehicle, the active noise control circuit 12 may be mounted on a circuit board with a male connector, wherein the circuit board 30 has a female connector, in which case the active noise control circuit 12 and the circuit board 30 may be connected to each other through such male and female connectors.

The active noise control circuit 12 is in the form of a microcomputer, and generates a noise control signal Scn for canceling out noise produced by the engine of the vehicle based on an engine pulse Ep, which is generated by a Hall device or the like per revolution of the output shaft of the engine, and based on an error signal e that is generated on the basis of sounds including noise detected by the condenser microphone 16. The noise control signal Scn is supplied to the adder 22.

The audio circuit 14 is in the form of a microcomputer, and outputs an audio signal Sa, which is generated by processing an audio signal input from a sound source such as an AM/FM radio unit, a cassette tape, a CD, or the like selected through a console panel, not shown. The audio signal Sa is supplied to the adder 22.

The adder 22 supplies the noise control signal Scn and/or the audio signal Sa to the amplifier 24, which amplifies the supplied signal and applies the amplified signal to the speaker 26. Based on the applied signal, the speaker 26 radiates control sounds and/or music sounds into the passenger compartment. The speaker 26 may include plural speakers mounted in the vehicle doors, not shown, which are disposed laterally of front seats of the vehicle, and also mounted behind a rear seat of the vehicle.

As disclosed in Japanese Laid-Open Patent Publication No. 61-112496, the condenser microphone 16 detects noise in the passenger compartment, which includes sounds generated by the audio signal Sa. The active noise control circuit 12 subtracts the audio signal Sa, which has been delayed by a time period based on a sound propagation time within the passenger compartment, from the input signal supplied by the condenser microphone 16, so as to detect a noise signal component. Then, the active noise control circuit 12 inverts the noise signal component in order to produce the noise control signal Scn, which is in opposite phase with the noise signal component, and outputs the noise control signal Scn to the adder 22. The adder 22 combines the audio signal Sa and the sound control signal Scn, and the speaker 26 outputs sounds into the passenger compartment based on the combined signal, which is supplied from the adder 22 through the amplifier 24. In this manner, noise inside the passenger compartment is reduced, without impairing the sound that is reproduced from the sound source such as an AM/FM radio unit, a cassette tape, a CD, or the like.

The first power supply voltage regulating circuit 18 supplies a first power supply voltage V1 to the active noise control circuit 12 and to the audio circuit 14. The second power supply voltage regulating circuit 20 supplies a second power supply voltage V2 to the condenser microphone 16, the adder 22, and the amplifier 24. The first power supply voltage regulating circuit 18 and the second power supply voltage regulating circuit 20 stably generate the first and second power supply voltages V1, V2 by lowering a battery voltage Vb supplied from a battery on the vehicle. The second power supply voltage V2 generated by the second power supply voltage regulating circuit 20 is higher than the first power supply voltage V1 generated by the first power supply voltage regulating circuit 18. For example, the second power supply voltage V2 generated by the second power supply voltage regulating circuit 20 is V2=12 V and is supplied mainly to analog components, whereas the first power supply voltage V1 generated by the first power supply voltage regulating circuit 18 is V1=5V and is supplied mainly to digital components.

In the in-vehicle noise/vibration sound control system 10 according to the first embodiment, as described above, based on the battery voltage Vb, the first power supply voltage regulating circuit 18 generates and supplies the first power supply voltage V1 to both the active noise control circuit 12 and the audio circuit 14, whereas the second power supply voltage regulating circuit 20 generates and supplies the second power supply voltage V2 to the condenser microphone 16, the adder 22, and the amplifier 24. Accordingly, the in-vehicle noise/vibration sound control system 10 is made smaller in size and weight, and is also lower in cost than the integrated system 60 shown in FIG. 4.

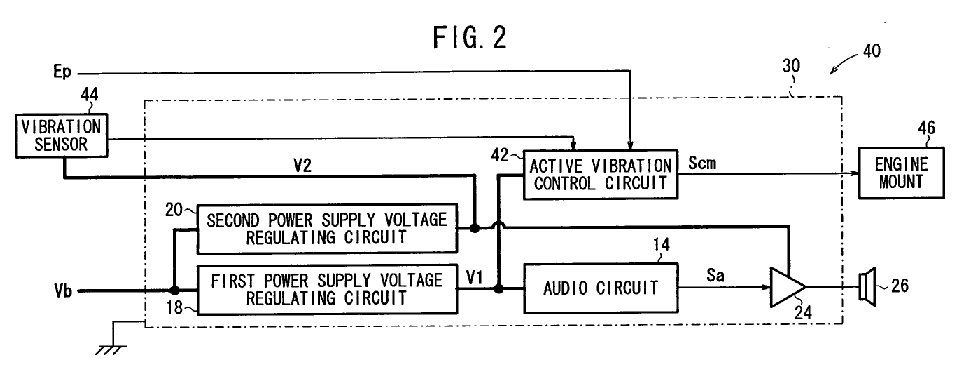

FIG. 2 shows in block form an in-vehicle noise/vibration sound control system 40 according to a second embodiment of the present invention.

As shown in FIG. 2, the in-vehicle noise/vibration sound control system 40 according to the second embodiment differs from the in-vehicle noise/vibration sound control system 10 shown in FIG. 1 in that it includes an active vibration control circuit 42 instead of the active noise control circuit 12 shown in FIG. 1. Further, a vibration sensor 44 is used instead of the condenser microphone 16 shown in FIG. 1. Additionally, the in-vehicle noise/vibration sound control system 40 has an engine mount 46.

The active vibration control circuit 42 is in the form of a microcomputer, and generates a vibration control signal Scm for canceling out vibrations produced by the engine of the vehicle, based on an engine pulse Ep which is generated by a Hall device or the like per revolution of the output shaft of the engine, and vibrations detected by the vibration sensor 44. The vibration control signal Scm is supplied to the engine mount 46.

The engine mount 46 reduces vibrations of the engine based on the vibration control signal Scm supplied from the active vibration control circuit 42.

In the in-vehicle noise/vibration sound control system 40 according to the second embodiment, based on the battery voltage Vb, the first power supply voltage regulating circuit 18 generates and supplies the first power supply voltage V1 to both the active vibration control circuit 42 and to the audio circuit 14, whereas the second power supply voltage regulating circuit 20 generates and supplies the second power supply voltage V2 to both the vibration sensor 44 and to the amplifier 24. With this arrangement, the in-vehicle noise/vibration sound control system 40 is smaller in size and weight than the integrated system 60 shown in FIG. 4, as well as being lower in cost.

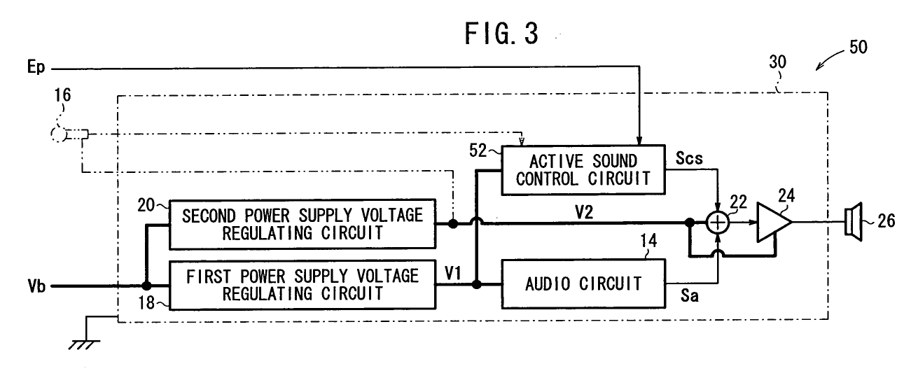

FIG. 3 shows in block form an in-vehicle noise/vibration sound control system 50 according to a third embodiment of the present invention.

As shown in FIG. 3, the in-vehicle noise/vibration sound control system 50 according to the third embodiment differs from the in-vehicle noise/vibration sound control system 10 shown in FIG. 1 in that it includes an active sound control circuit 52 instead of the active noise control circuit 12 shown in FIG. 1.

The active sound control circuit 52 is in the form of a microcomputer, and generates a sound control signal Scs representative of a sound change depending on a running state of the vehicle, based on an engine pulse Ep which is generated by a Hall device or the like per revolution of the output shaft of the engine. The sound control signal Scs is supplied to the adder 22. The sound control signal Scs and the audio signal Sa from the audio circuit 14 are combined with each other by the adder 22, and the combined signal is amplified by the amplifier 24. The amplified signal is output from the amplifier 24 to the speaker 26, which outputs a sound effect into the passenger compartment.

In the in-vehicle noise/vibration sound control system 50 according to the third embodiment, based on the battery voltage Vb, the first power supply voltage regulating circuit 18 generates and supplies the first power supply voltage V1 to both the active sound control circuit 52 and to the audio circuit 14, whereas the second power supply voltage regulating circuit 20 generates and supplies the second power supply voltage V2 to both the adder 22 and to the amplifier 24.

As shown in FIG. 3, the condenser microphone 16 may be added to the in-vehicle noise/vibration sound control system 50, wherein the active sound control circuit 52 generates a sound control signal Scs representative of a sound change depending on a running state of the vehicle, based on sounds detected by the condenser microphone 16 along with the engine pulses Ep. If the condenser microphone 16 is added, then in this case, the second power supply voltage regulating circuit 20 supplies the second power supply voltage V2 to the condenser microphone 16, the adder 22, and to the amplifier 24.

With the above arrangement, the in-vehicle noise/vibration sound control system 50 is made smaller in size and weight, and is lower in cost than the integrated system 60 shown in FIG. 4.

Although certain preferred embodiments of the present invention have been shown and described in detail, it should be understood that various changes and modifications may be made to the embodiments without departing from the scope of the invention as set forth in the appended claims.

What is claimed is:

1. An in-vehicle noise/vibration sound control system comprising:
a circuit board;
a control circuit mounted on said circuit board, said control circuit comprising at least one of an active noise control circuit for generating a noise control signal for reducing noise in a passenger compartment of a vehicle, an active vibration control circuit for generating a vibration control signal for reducing vibration of the vehicle, and an active sound control circuit for generating a sound control signal representative of a sound change depending on a running state of the vehicle;
an audio circuit mounted on said circuit board for generating and supplying an audio signal to a speaker to output music sounds therefrom; and
a first power supply voltage regulating circuit mounted on said circuit board for generating a first power supply voltage based on a battery voltage supplied from a battery on the vehicle, and supplying said first power supply voltage to said control circuit and to said audio circuit.

2. An in-vehicle noise/vibration sound control system according to claim 1, further comprising:
a microphone connected to an input of said active noise control circuit or said active sound control circuit;
an adder mounted on said circuit board for combining said noise control signal or said sound control signal with said audio signal; and
a second power supply voltage regulating circuit mounted on said circuit board for generating a second power supply voltage based on said battery voltage, and supplying said second power supply voltage to said microphone and to said adder.

3. An in-vehicle noise/vibration sound control system according to claim 1, further comprising:
a vibration sensor connected to an input of said active vibration control circuit; and
a second power supply voltage regulating circuit mounted on said circuit board for generating a second power supply voltage based on said battery voltage, and supplying said second power supply voltage to said vibration sensor.

4. An in-vehicle noise/vibration sound control system according to claim 1, further comprising:
an adder mounted on said circuit board for combining said sound control signal with said audio signal; and
a second power supply voltage regulating circuit mounted on said circuit board for generating a second power supply voltage based on said battery voltage, and supplying said second power supply voltage to said adder.

5. An in-vehicle noise/vibration sound control system comprising:
a circuit board;
a control circuit mounted on said circuit board, said control circuit comprising at least one of an active noise control circuit for generating a noise control signal for reducing noise in a passenger compartment of a vehicle, an active vibration control circuit for generating a vibration control signal for reducing vibration of the vehicle, and an active sound control circuit for generating a sound control signal representative of a sound change depending on a running state of the vehicle;
an audio circuit mounted on said circuit board for generating and supplying an audio signal to a speaker to output music sounds therefrom;
a microphone connected to an input of said active noise control circuit or said active sound control circuit;
an adder mounted on said circuit board for combining said noise control signal or said sound control signal with said audio signal; and
a power supply voltage regulating circuit mounted on said circuit board for generating a power supply voltage based on a battery voltage supplied from a battery on the vehicle, and supplying said power supply voltage to said microphone and to said adder.

6. An in-vehicle noise/vibration sound control system comprising:
a circuit board;
a control circuit mounted on said circuit board, said control circuit comprising at least one of an active noise control circuit for generating a noise control signal for reducing noise in a passenger compartment of a vehicle, an active vibration control circuit for generating a vibration control signal for reducing vibration of the vehicle, and an active sound control circuit for generating a sound control signal representative of a sound change depending on a running state of the vehicle;
an audio circuit mounted on said circuit board for generating and supplying an audio signal to a speaker to output music sounds therefrom;
a vibration sensor connected to an input of said active vibration control circuit; and
a power supply voltage regulating circuit mounted on said circuit board for generating a power supply voltage based on a battery voltage supplied from a battery on the vehicle, and supplying said power supply voltage to said vibration sensor.

7. An in-vehicle noise/vibration sound control system comprising:
a circuit board;
a control circuit mounted on said circuit board, said control circuit comprising at least one of an active noise control circuit for generating a noise control signal for reducing noise in a passenger compartment of a vehicle, an active vibration control circuit for generating a vibration control signal for reducing vibration of the vehicle, and an active sound control circuit for generating a sound control signal representative of a sound change depending on a running state of the vehicle;
an audio circuit mounted on said circuit board for generating and supplying an audio signal to a speaker to output music sounds therefrom;
an adder mounted on said circuit board for combining said sound control signal with said audio signal; and
a power supply voltage regulating circuit mounted on said circuit board for generating a power supply voltage based on a battery voltage supplied from a battery on the vehicle, and supplying said power supply voltage to said adder.
